(19) United States
(12) Patent Application Publication
(10) Pub. No.: US 2014/0304738 A1
(43) Pub. Date: Oct. 9, 2014

(54) WEB BROWSER CONTROL DEVICE, WEB BROWSER CONTROL METHOD, AND TELEVISION RECEIVER

(71) Applicants: Hideaki Nakaoka, Osaka (JP); Tsuyoshi Ide, Osaka (JP)

(72) Inventors: Hideaki Nakaoka, Osaka (JP); Tsuyoshi Ide, Osaka (JP)

(21) Appl. No.: 14/359,322

(22) PCT Filed: Jun. 26, 2012
(86) PCT No.: PCT/JP2012/004134

§ 371 Date: May 20, 2014

(30) Foreign Application Priority Data
Dec. 26, 2011 (JP) 2011-284215

(51) Int. Cl. G06F 17/30; H04N 21/435; G06F 17/22

(52) U.S. Cl. CPC G06F 17/30884; G06F 17/2247; H04N 21/435
USPC 725/37; 715/206

(57) ABSTRACT

A web browser control device includes: a display control unit that causes web pages and a bookmark list screen showing a list of at least one bookmarked web page among the web pages to be displayed; a storage unit that stores (a) pieces of history information of the web pages displayed by the display control unit and (b) bookmark information of the at least one bookmarked web page; and a web browser control unit that (i) instructs, when a web browser is opened, the display control unit to cause the bookmark list screen to be displayed according to the bookmark information stored in the storage unit, and (ii) delete, when the web browser is closed or opened, (c) history information of at least one web page not bookmarked among the web pages from the storage unit.

### TECHNICAL FIELD

The present invention relates to a web browser control device with a web browser, and a web browser control method. The present invention also relates to a television receiver provided with a web browser and accessible to the Internet.

### BACKGROUND ART

In recent years, information devices provided with a web browser for browsing web pages and accessible to the Internet have been developed and getting widely used. The conventional web browsers are classified into two types; a type for browsing web pages in a normal browsing mode (for example, see Patent Literature 1 (PLT 1)) and a type for browsing web pages in a private browsing mode (for example, see Patent Literature 2 (PLT 2)).

In the normal browsing mode, pieces of history information of web pages (hereinafter, referred to also simply as pieces of “history information”) are stored in a storage area during a period from opening of a web browser to closing of the web browser. The pieces of history information stored in the storage area are kept in the storage area even after the web browser is closed.

In the private browsing mode, pieces of history information of web pages are also stored in a storage area during a period from opening of a web browser to closing of the web browser. All the pieces of history information stored in the storage area are deleted when the web browser is closed.

Here, pieces of history information of a web page include a cookie, cache data, input history data, and the like. A cookie is identification information exchanged between a web server and a web browser. A cookie is used, for example, for user identification, authentication, session management, storing of web page customizing information, and the like. Cache data is data of a web page which is temporarily stored in a storage device. By temporarily storing data of a frequently-used web page in a storage device, it is possible to increase a processing speed by eliminating a temporal loss of reading the data of the web page from a web server through a network. Input history data is character string data which a user has inputted in an input area of a web page. Input history data is used for an auto-complete function provided to a web browser. An auto-complete function is a function for predicting an input next to a user's current input with reference to input history data and presenting the predicted input to the user as a candidate.

### CITATION LIST

### Patent Literatures

[PTL 1] Japanese Unexamined Patent Application Publication No. 2011-96028
[PTL 2] Japanese Patent No. 4574327

### SUMMARY OF INVENTION

### Technical Problem

However, the above-described conventional information devices accessible to the Internet have a problem of failing to sufficiently protect privacy and having a low usability in browsing web pages.

Thus, the present invention overcomes the problems of the conventional techniques as described above. It is an object of the present invention to provide a web browser control device, a web browser control method, and a television receiver, each of which is capable of protecting privacy which a usability in browsing web pages is enhanced.

### Solution to Problem

In accordance with an aspect of the present invention for achieving the object, there is provided a web browser control device comprising: a display control unit configured to cause web pages and a bookmark list screen to be displayed, the bookmark list screen showing a list of at least one bookmarked web page among the web pages: a storage unit configured to store (a) pieces of history information of the web pages displayed by the display control unit and (b) bookmark information of the at least one bookmarked web page; and a web browser control unit configured to (i) instruct, when a web browser is opened, the display control unit to cause the bookmark list screen to be displayed according to the bookmark information stored in the storage unit, and (ii) delete, when the web browser is closed or opened, (c) history information of at least one web page not bookmarked among the web pages from the storage unit.

It should be noted that the general and specific aspect may be implemented to a system, a method, an integrated circuit, a computer program, or a computer-readable recording medium such as a Compact Disk Read Only Memory (CD-ROM), or may be any combination of them

### Advantageous Effects of Invention

The web browser control device, the web browser control method, and the television receiver according to the present invention are capable of protecting privacy while a usability in browsing web pages is enhanced.

### BRIEF DESCRIPTION OF DRAWINGS

FIG. 1 is a block diagram illustrating a structure of a web browser control device according to Embodiment 1 of the present invention.

FIG. 2 is a block diagram illustrating a structure of a web browser control unit in FIG. 1.

FIG. 3 is a diagram for explaining a method of examining a domain and a path by a domain examination unit.

FIG. 4 is a diagram illustrating a bookmark list screen.

FIG. 5 is an enlarged diagram of a part of the bookmark list screen.

FIG. 6 is a flowchart of a web browser control method performed by the web browser control device according to Embodiment 1.

FIG. 7 is a flowchart of a detailed flow of a history information deletion step in FIG. 6.

FIG. 8 is a block diagram illustrating a structure of a web browser control unit in a web browser control device according to Embodiment 2 of the present invention.

FIG. 9 is a flowchart of a web browser control method performed by the web browser control device according to Embodiment 2.

FIG. 10 is a flowchart of a detailed flow of a cookie storing step in FIG. 9.

FIG. 11 is a block diagram illustrating a structure of a web browser control unit in a web browser control device according to Embodiment 3 of the present invention.

FIG. 12 is a flowchart of a web browser control method performed by the web browser control device according to Embodiment 3.

FIG. 13 is a flowchart of a detailed flow of a cookie transmission step in FIG. 12.

FIG. 14 is an external oblique perspective view of a television receiver according to Embodiment 4.

FIG. 15 is a block diagram illustrating a structure of television receiver of FIG. 14.

### DESCRIPTION OF EMBODIMENTS

### Observation Based on which Present Invention is Conceived

The inventors of the present invention found the following problems in the information devices accessible to the Internet as disclosed in “Background Art”. For example, a television receiver accessible to the Internet is generally used by a plurality of users such as a family and relatives. If a television receiver is used by a plurality of users, for the type of browsing web pages in the normal browsing mode, the users share pieces of history information of web pages. There is therefore a risk, for example, that cookies are shared by the plurality of users so that a purchase history or the like indicating that a certain user has purchased an item through a web site of Internet shopping is read by another user in a family or relatives who uses the information device afterwards. As described above, the normal browsing mode has a problem of failing to sufficiently protect privacy.

On the other hand, for the type of browsing web pages in the private browsing mode, pieces of history information which are allowed to be shared by a plurality of users, such as web page customizing information and the like, are deleted when the web browser is closed. Therefore, for example, each of the users has to re-customize a web page every time a web browser is opened. As a result, the private browsing mode has a problem of significantly lowering a usability in browsing web pages.

Here, if a user can switch between the normal browsing mode and the private browsing mode, it is necessary for the user to understand the meaning of the private browsing mode and acquire a method of switching the browsing modes, and then consciously switch between the normal browsing mode and the private browsing mode before browsing a web page. Therefore, this case also causes a problem of lowering a usability in browsing web pages.

In accordance with an aspect of the present invention for achieving the object, there is provided a web browser control device comprising: a display control unit configured to cause web pages and a bookmark list screen to be displayed, the bookmark list screen showing a list of at least one bookmarked web page among the web pages: a storage unit configured to store (a) pieces of history information of the web pages displayed by the display control unit and (b) bookmark information of the at least one bookmarked web page; and a web browser control unit configured to (i) instruct, when a web browser is opened, the display control unit to cause the bookmark list screen to be displayed according to the bookmark information stored in the storage unit, and (ii) delete, when the web browser is closed or opened, (c) history information of at least one web page not bookmarked among the web pages from the storage unit.

With the above structure, a list of bookmarked (favorite) web pages is displayed when a web browser is opened, so that a user can easily recognize that other users sharing the same information device can see the list. The user is generally unlikely to bookmark a web page which the user does not want other users to know as a web page browsed by the user, namely, a web page for which the user does not want to share history information, because a bookmarked web page is displayed every time the web browser is opened. Therefore, with the above structure, pieces of history information of web pages not bookmarked are deleted from the storage unit when the web browser is closed or opened, so that privacy can be protected without user's operation of switching browsing modes. On the other hand, pieces of history information of web pages that have been bookmarked are kept being stored in the storage unit. It is therefore possible, for example, to keep customizing information and the like of the web pages even if the user is switched to another. As a result, a usability in browsing by the web browser can be enhanced. Moreover, the user is likely to bookmark web pages that the user frequently browses. Therefore, the bookmark list screen is displayed by the display control unit when the web browser is opened, so that the user can more easily access the web pages that the user frequently browses.

For example, it is possible that the storage unit includes a storage area, the storage area including a nonvolatile storage area and a volatile storage area, the storage area holds (a) the pieces of the history information of the web pages displayed by the display control unit and (b) the bookmark information of the at least one bookmarked web page, and the web browser control unit is configured, when the web browser is closed or opened, to delete, from the storage area, (c) the history information of the at least one web page not bookmarked among (a) the pieces of the history information of the web pages stored in the storage area, according to (a) the pieces of the history information of the web pages and (b) the bookmark information which are stored in the storage area.

With the above structure, pieces of history information of web pages not bookmarked are deleted from the storage area when the web browser is closed or opened, so that privacy is sufficiently protected.

For example, it is also possible that the storage area holds (a1) domains of the pieces in the history information of the web pages displayed by the display control unit and (b1) a domain in a Uniform Resource Locator (URL) of the at least one bookmarked web page, and the web browser control unit includes: a domain examination unit configured, when the web browser is closed or opened, to determine, for each of (a1) the domains in the pieces of the history information of the web pages stored in the storage area, whether or not a target domain includes (b1) the domain in the URL of the at least one bookmarked web page; and a processing unit configured, when the web browser is closed or opened, to (i) keep holding history information having the target domain in the storage area when the domain examination unit determines that the target domain includes the domain in the URL, and (ii) delete the history information having the target domain from the storage area when the domain examination unit determines that the target domain does not include the domain in the URL.

With the above structure, it is possible to surely delete pieces of history information of web pages not bookmarked from the storage area when the web browser is closed or opened.

For example, it is further possible that the storage unit includes a first storage area and a second storage area, the first storage area holds (b) the bookmark information of the at least one bookmarked web page, and the web browser control unit is configured to during a period from when the web browser is opened to when the web browser is closed, according to (b) the bookmark information stored in the first storage area, (i) store, into the first storage area, (b2) history information of the at least one bookmarked web page among the web pages displayed by the display control unit, and (ii) store, into the second storage area, (c) the history information of the at least one web page not bookmarked among the web pages displayed by the display control unit; and delete, from the second storage area, (c) the history information of the at least one web page not bookmarked when the web browser is closed or opened.

With the above structure, pieces of history information of web pages not bookmarked are deleted from the second storage area when the web browser is closed or opened, so that privacy is sufficiently protected. Furthermore, pieces of history information of bookmarked web pages are kept being stored in the First storage area, so that a usability in browsing by the web browser can be enhanced.

For example, it is ill further possible that the first storage area holds (b1) a domain in a URL of the at least one bookmarked web page, and the web browser control unit includes a domain examination unit configured, during a period from when the web browser is opened to when the web browser is closed, to determine, for each of (a1) domains in the pieces of the history information of the web pages displayed by the display control unit, whether or not a target domain includes (b1) the domain in the URL of the at least one bookmarked web page; and a processing unit configured to (i−1) store history information having the target domain into the first storage area when the domain examination unit determines that the target domain includes the domain in the URL, and (i−2) store the history information having the target domain into the second storage area when the domain examination unit determines that the target domain does not include the domain in the URL, and (ii) delete the history information having the target domain from the second storage area when the web browser is closed or opened.

With the above structure, it is possible to surely store pieces of history information of bookmarked web pages into the first storage area during a period from when the web browser is opened and to when the web browser is closed, and delete pieces of history information of web pages not bookmarked from the second storage area.

For example, it is still further possible that the first storage area is a nonvolatile storage area, and the second storage area is a volatile storage area.

With the above structure, since the first storage area is a nonvolatile storage area, it is possible to hold pieces of history information of bookmarked web pages in the first storage area when the web browser control device is powered OFF. Furthermore, since the second storage area is a volatile storage area, it is possible to erase pieces of history information of web pages not bookmarked from the second storage area when the web browser control device is powered OFF.

For example, it is still further possible that the storage unit includes a first storage area and a second storage area, the first storage area holds (b) the bookmark information of the at least one bookmarked web page, and the web browser control unit is configured, during a period from when the web browser is opened to when the web browser is closed, to: (i) store (a) the pieces of the history information of the web pages displayed by the display control unit into both the first storage area and the second storage area, (ii) use the pieces of history information of the web pages which are stored in the second storage area when (e) history information of a web page to be used is stored in the second storage area, and (ii) determine, according to (b) the bookmark information stored in the first storage area, whether or not to use each of the pieces of the history information of the web pages which are stored in the first storage area when (e) the history information of the web page to be used is not stored in the second storage area; and delete the pieces of the history information stored in the second storage area when the web browser is closed or opened.

With the above structure, pieces of history information of web pages not bookmarked are deleted from the second storage area when the web browser is closed or opened, so that privacy is sufficiently protected.

For example, it is still further possible that the first storage area holds (b1) a domain in a URL of the at least one bookmarked web page, and the web browser control unit includes: a domain examination unit configured, during a period from when the web browser is opened to when the web browser is closed, when (e) the history information of the web page to be used is not stored in the second storage area, to determine whether or not (e1) a domain in the history information of the web page to be used includes (b1) the domain in the URL of the at least one bookmarked web page; and a processing unit configured (i) to use the pieces of the history information stored in the first storage area when the domain examination unit determines that (e1) the domain in the history information of the web page to be used includes (b1) the domain in the URL, (ii) not to use the pieces of the history information stored in the first storage area when the domain examination unit determines that (e1) the domain in the history information of the web page to be used does not include (b1) the domain in the URL, and (iii) to delete the pieces of the history information of the web pages which are stored in the second storage area when the web browser is closed or opened.

With the above structure, it is possible, during a period from when the web browser is opened to when the web browser is closed, to surely permit use of pieces of history information of bookmarked web pages among pieces of history information of web pages stored in the first storage area, and prohibit use of pieces of history information of web pages not bookmarked among the pieces of the history information stored in the first storage area.

For example, it is still further possible that the first storage area is a nonvolatile storage area, and the second storage area is a volatile storage area.

With the above structure, since the first storage area is a nonvolatile storage area, it is possible to hold pieces of history information of bookmarked web pages in the first storage area when the web browser control device is powered OFF. Furthermore, since the second storage area is a volatile storage area, it is possible to erase pieces of history information of web pages not bookmarked from the second storage area when the web browser control device is powered OFF.

For example, t is still further possible that the web browser control unit is configured to delete, from the storage unit, (a) the pieces of the history information of the web pages except (b2′) history information having a domain and a sub-domain of the at least one bookmarked web page when the web browser is closed or opened.

With the above structure, it is possible to enhance a usability of browsing bookmarked web pages.

For example, it is still further possible that the web browser control unit is configured to delete, from the storage unit, (a) the pieces of the history information of the web pages except (b2″) history information having a domain and a sub-directory of the at least one bookmarked web page when the web browser is closed or opened.

With the above structure, it is possible to enhance a usability of browsing bookmarked web pages.

For example, it is still further possible that the web browser control unit is configured to delete history information of a certain web page from the storage unit when bookmark information of the certain web page is deleted from the storage unit.

With the above structure, when bookmark information of a certain web page is deleted from the storage unit, history information of the certain web page is not kept in the storage unit any longer. As a result, privacy can be surely protected.

For example, it is still further possible that (a) the pieces of the history′ information stored in the storage unit include at least one of a cookie, cache data, input history data, web page browsing history data, and web page relevance data.

With the above structure, pieces of history information of a web page which are stored in the storage unit may include at least one of a cookie, cache data, input history data, web page browsing history data, and web page relevance data.

For example, it is still further possible that the web page relevance data is one of a screen image and a referrer.

With the above structure, the web page relevance data may be a screen image or a referrer.

For example, it is still further possible that the web page relevance data is stored in the storage unit in association with a domain of a web page for which the web page relevance data is obtained.

With the above structure, it is possible to perform processing (for example, deleting, storing, or using) on the web page relevance data according to a domain of a web page for which web page relevance data is obtained.

For example, it is still further possible that the input history data is stored in the storage unit in association with a domain of a web page on which an input indicated by the input history data is performed.

With the above structure, it is possible to perform processing (for example, deleting, storing, or using) on the input history data according to a domain of a web page on which input indicated in the input history data is performed.

In accordance with another aspect of the present invention, there is provided the display control unit is configured to (i) display, on the bookmark list screen, a plurality of bookmark display items each corresponding to a corresponding one of bookmarked web pages among the web pages, allowing the bookmark display items to be focus-displayed one by one, and (ii) display a deletion menu on the bookmark list screen when a certain bookmark display item among the bookmark display items is focus-displayed, the deletion menu being used to delete history information of a web page corresponding to the certain bookmark display item from the storage unit.

With the above structure, by using the deletion menu displayed on the bookmark list screen, it is possible to delete history information of a web page corresponding to a certain bookmark display item that is focus-displayed.

For example, it is possible that the display control unit is configured to (i) display, on the bookmark list screen, a plurality of bookmark display items each corresponding to a corresponding one of bookmarked web pages, allowing the bookmark display items to be focus-displayed one by one, and (ii) display a setting menu on the bookmark list screen when a certain bookmark display item among the bookmark display items is focus-displayed, the setting menu being used to set whether or not to store history information of a web page corresponding to the certain bookmark display item into the storage unit.

With the above structure, by using a setting menu displayed on the bookmark list screen, it is possible to set whether or not to store, into the storage unit, history information of a web page corresponding to a certain bookmark display item that is focus-displayed.

For example, it is also possible that the display control unit is configured, when the setting menu is set to store the history information of the web page corresponding to the certain bookmark display item into the storage unit, to display, on the bookmark list screen, a display showing that the history information of the web page corresponding to the certain bookmark display item is set to be stored in the storage unit.

With the above structure, by seeing the displayed bookmark list screen, the user can easily recognize that it is set to store history information of a certain web page into the storage unit.

For example, it is further possible that the display control unit is configured, when the setting menu is set not to store the history information of the web page corresponding to the certain bookmark display item into the storage unit, to display, on the bookmark list screen, a display showing that the history information of the web page corresponding to the certain bookmark display item is set not to be stored in the storage unit.

With the above structure, by seeing the displayed bookmark list screen, the user can easily recognize that it is set not to store history information of a certain web page into the storage unit.

For example, it is still further possible that the display control unit is configured to virtually arrange the bookmark display items in a substantially cylindrical shape on the bookmark list screen, and virtually rotate the bookmark display items in a predetermined direction.

With the above structure, even if all of bookmark display items in the bookmark list is not displayed within a screen, it is possible to display all the bookmark display items without reducing a display size. Therefore, the user can see more bookmark display items before starting browsing without reduction of visibility. As a result, in the aspect of the present invention, more bookmark display items can be dealt.

For example, it is still further possible that each of the bookmark display items is an image generated by capturing a screen of a corresponding one of the bookmarked web pages.

With the above structure, by seeing the bookmark display items, the user can visually and easily recognize details of the bookmarked web pages.

In accordance with still another aspect of the present invention, there is provided a web browser control method comprising: displaying, on a display unit, a bookmark list screen showing a list of at least one bookmarked web page when a web browser is opened; storing, in a storage unit, pieces of history information of web pages displayed on the display unit, during a period from when the web browser is opened and to when the web browser is closed; and deleting, from the storage unit, history information of at least one web page not bookmarked among the web pages, when the web browser is closed or opened.

With the above structure, a list of bookmarked (favorite) web pages is displayed when a web browser is opened, so that a user can easily recognize that other users sharing the same information device can see the list. The user is generally unlikely to bookmark a web page which the user does not want other users to know as a web page browsed by the user, namely, a web page for which the user does not want to share history information, because a bookmarked web page is displayed every time the web browser is opened. Therefore, with the above structure, pieces of history information of web pages not bookmarked are deleted from the storage unit when the web browser is closed or opened, so that privacy can be protected without user's operation of switching browsing modes. On the other hand, pieces of history information of web pages that have been bookmarked are kept being stored in the storage unit. It is therefore possible, for example, to keep customizing information and the like of the web pages even if the user is switched to another. As a result, a usability in browsing by the web browser can be enhanced. Moreover, the user is likely to bookmark web pages that the user frequently browses. Therefore, the bookmark list screen is displayed by the display control unit when the web browser is opened, so that the user can more easily access the web pages that the user frequently browses.

In accordance with still another aspect of the present invention for achieving the object, there is provided a television receiver comprising: a display unit; a display control unit configured to cause the display unit to display web pages and a bookmark list screen, the bookmark list screen showing a list of at least one bookmarked web page among the web pages; a storage unit configured to store (a) pieces of history information of the web pages displayed by the display control unit and (b) bookmark information of the at least one bookmarked web page; and a web browser control unit configured to (i) instruct, when a web browser is opened, the display control unit to cause the bookmark list screen to be displayed according to the bookmark information stored in the storage unit, and (ii) delete, when the web browser is closed or opened, (c) history information of at least one web page not bookmarked among the web pages from the storage unit.

With the above structure, a list of bookmarked (favorite) web pages is displayed when a web browser is opened, so that a user can easily recognize that other users sharing the same information device can see the list. The user is generally unlikely to bookmark a web page which the user does not want other users to know as a web page browsed by the user, namely, a web page for which the user does not want to share history information, because a bookmarked web page is displayed every time the web browser is opened. Therefore, with the above structure, pieces of history information of web pages not bookmarked are deleted from the storage unit when the web browser is closed or opened, so that privacy can be protected without user's operation of switching browsing modes. On the other hand, pieces of history information of web pages that have been bookmarked are kept being stored in the storage unit. It is therefore possible, for example, to keep customizing information and the like of the web pages even if the user is switched to another. As a result, a usability in browsing by the web browser can be enhanced. Moreover, the user is likely to bookmark web pages that the user frequently browses. Therefore, the bookmark list screen is displayed by the display control unit when the web browser is opened, so that the user can more easily access the web pages that the user frequently browses.

It should be noted that the general and specific aspect may be implemented to a system, a method, an integrated circuit, a computer program, or a computer-readable recording medium such as a CD-ROM, or may be any combination of them.

### EMBODIMENTS

The following describes various embodiments of the web browser control device, the web browser control method, and the television receiver according to the present invention in detail with, reference to the drawings. It should be noted that all the embodiments described below are specific examples of the present invention. Numerical values, shapes, materials, constituent elements, arrangement positions and the connection configuration of the constituent elements, steps, the order of the steps, and the like described in the following embodiments are merely examples, and are not intended to limit the present invention. Therefore, among the constituent elements in the following embodiments, constituent elements that are not described in independent claims that show the most generic concept of the present invention are described as elements constituting more desirable configurations,

### Embodiment 1

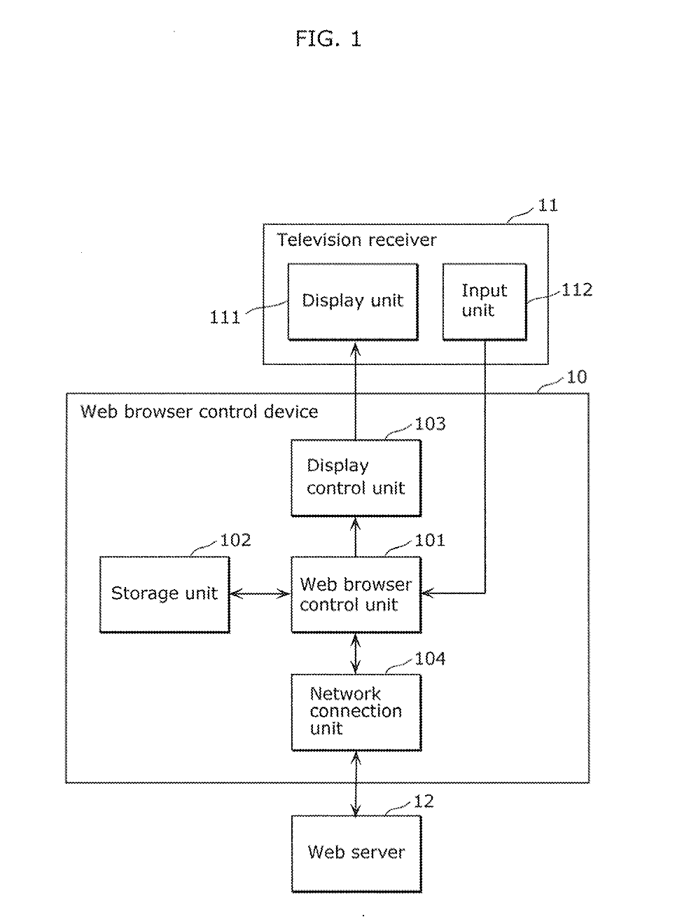

FIG. 1 is a block diagram illustrating a structure of a web browser control device according to Embodiment 1 of the present invention. The web browser control device 10 is connected to, for example, a television receiver 11.

The television receiver 11 includes: a tuner unit (not shown) that obtains video signals by receiving broadcast signals; a display unit 111 that displays the obtained video signals and the like; and an input unit 112 that is used to operate a display screen or the like displayed on the display unit 111. The display unit 111 is, for example, a liquid crystal display. The input unit 112 is, for example, a remote controller. A user operates the input unit 112 to, for example, operate a bookmark list screen (as described later) displayed on the display unit 111, or input character strings in an input area in a web page displayed on the display unit 111.

It should be noted that it has been described in the present embodiment that the web browser control device 10 and the television receiver 11 are separate devices, but they may be integrated together.

As illustrated in FIG. 1, the web browser control device 10 includes a web browser control unit 101, a storage unit 102, a display control unit 103, and a network connection unit 104.

The web browser control unit 101 downloads an HTML file, an image file, and the like from the web server 12 via the network connection unit 104, then analyzes a layout, and instructs the display control unit 103 to display a web page. The structure of the web browser control unit 101 will be described later. It should be noted that the web browser may be included in an application having a browsing function.

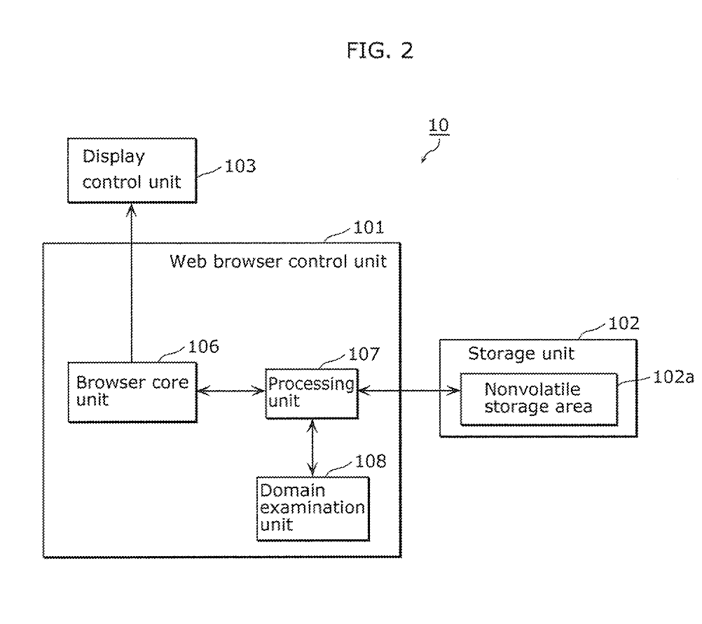

The storage unit 102 includes a nonvolatile storage area 102a (see FIG. 2) that is, for example, a nonvolatile memory or the like. The nonvolatile storage area 102a holds: pieces of history information each corresponding to a corresponding web page displayed on the display control unit 103 (in other words, browsed by the user); pieces of bookmark information each indicating a bookmarked web page; and the like.

In the present embodiment, pieces of history information of a web page include a cookie, cache data, and input history data. The cookie is identification data exchanged between the web server 12 and the web browser. The cache data is data of a web page which is temporarily stored in the storage device. The input history data is character string data which the user inputs in an input area of the web page. The input history data is used for auto-complete function provided to the web browser. It should be noted that input history data of a web page is stored in association with a Uniform Resource Locator (URL) of the web page on which the user has performed the inputting.

Furthermore, the bookmark information includes; a URL of a bookmarked (favorite) web page; thumbnail image data of the web page; and date/month/year of the bookmarking.

The display control unit 103 causes the display unit 111 to display a web page, a bookmark list screen (described later), and the like according to instructions from the web browser control unit 101.

The network connection unit 104 connects the web browser control unit 101 and the web server 12 to each other via the Internet.

In the web server 12, Hyper Text Markup Language (HTML) files, image files, and the like are accumulated. The web server 12 provides such HTML file, image file, and the like to the web browser control unit 101 via the network connection unit 104 as requested from the web browser control unit 101.

Next, the structure of the web browser control unit 101 is described. FIG. 2 is a block diagram illustrating the structure of the web browser control unit in FIG. 1. As illustrated in FIG. 2, the web browser control unit 101 includes a browser core unit 106, a processing unit 107, and a domain examination unit 108.

When the web browser is opened, the browser core unit 106 instructs the processing unit 107 to delete pieces of history information of web pages that have not been bookmarked. In addition, when the web browser is opened, the browser core unit 106 instructs the display control unit 103 to display a bookmark list screen. According to the instructions from the browser core unit 106, the display control unit 103 obtains pieces of bookmark information of web pages from the nonvolatile storage area 102a and thereby causes the display unit 111 to display the bookmark list screen.

According to the instructions from the browser core unit 106, the processing unit 107 obtains, from the nonvolatile storage area 102a, domains and paths of browsed and bookmarked web pages; and domains and paths in pieces of history information of all browsed web pages, and therefore instructs the domain examination unit 108 to examine the domains and paths. In addition, based on the examination results of the domain examination unit 108, the processing unit 107 deletes pieces of history information of web pages that have not been bookmarked, from among the pieces of history information stored in the nonvolatile storage area 102a.

According to the instructions from the processing unit 107, the domain examination unit 108 determines whether or not a domain and a path in history information of a target web page includes a domain and a path in a URL of any one of bookmarked web pages. If the domain examination unit 108 determines that the domain and the path in the history information include a domain and a path in a URL of a bookmarked web page, then the processing unit 107 causes the nonvolatile storage area 102a to keep holding the history information of the web page. On the other hand, if the domain examination unit 108 determines that the domain and the path in the history information do not include a domain and a path in a URL of any bookmarked web page, then the processing unit 107 deletes the history information of the web page from the nonvolatile storage area 102a.

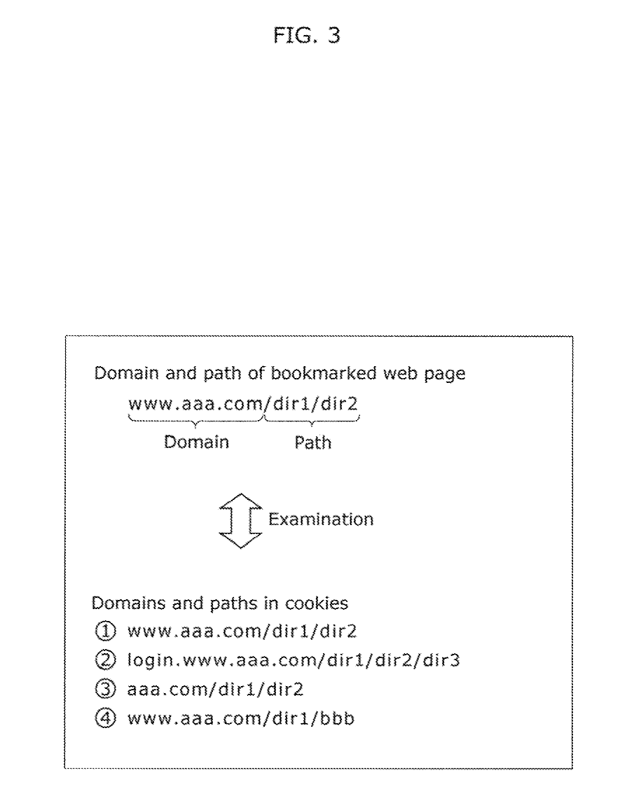

The domain examination unit 108 performs the domain, path examination in the following manner. FIG. 3 is a diagram for explaining how the domain examination unit 108 examines a domain and a path. As illustrated in FIG. 3, the following describes the situation where a domain and a path in a URL of one of bookmarked web pages are “www.aaa.com/dir1/dir2” and history information is a cookie. The domain examination unit 108 determines whether or not a domain in a cookie includes a domain of the bookmarked web page, by performing backward match search on a character string. In addition, the domain examination unit 108 determines whether or not a path of a cookie includes the path of the bookmarked web page, by performing forward match search on the character string.

If a domain and a path in a cookie are “www.aaa.com/dir1/dir2”, then the domain examination unit 108 determines that the domain and the path in the cookie include the domain and the path of the bookmarked web page, respectively. If a domain and a path in a cookie are “login.www.aaa.com/dir1/dir2/dir3”, then the domain examination unit 108 determines that the domain and the path in the cookie include the domain and the path of the bookmarked web page, respectively.

If a domain and a path in a cookie are “aaa.com/dir1/dir2”, then the domain examination unit 108 determines that the domain and the path in the cookie do not include the domain and the path of the bookmarked web page. If a domain and a path in a cookie are “www.aaa.com/dir1/bbb”, then the domain examination unit 108 determines that the domain and the path in the cookie do not include the domain and the path of the bookmarked web page.

The same examination as made to a cookie may be performed on cache data and input history data. For cache data, the domain/path examination is performed on a part of a URL except a file name, for a target cached web page. For input history data, the domain/path examination is performed on a domain and a path in a web page URL inputted by a user.

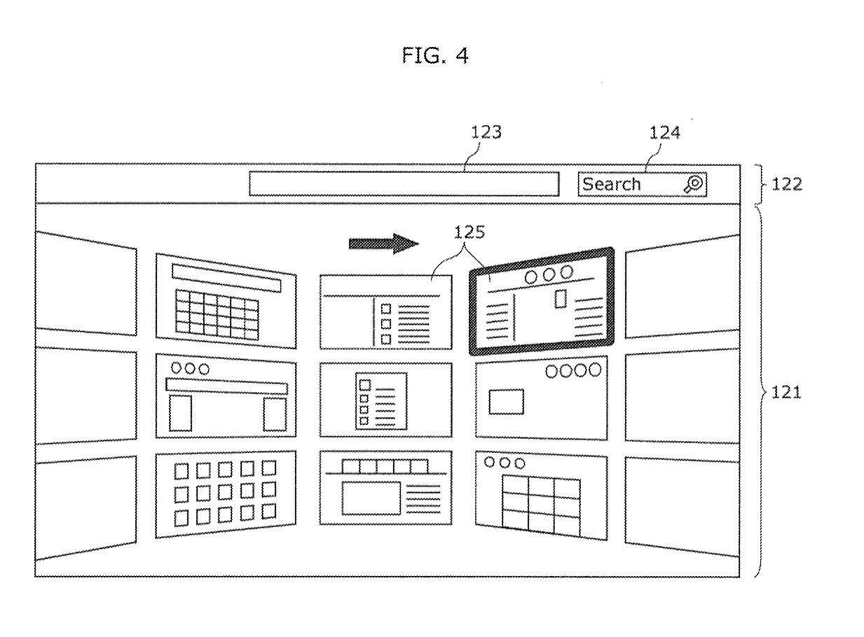

In the above manner, the display control unit 103 controls display of a bookmark list screen. The following describes this bookmark list screen. FIG. 4 is a diagram illustrating a bookmark list screen. As illustrated in FIG. 4, a bookmark list screen includes a display area 121 and a display bar 122 above the display area 121. The display bar 122 displays a location bar 123 and a search bar 124. In the location bar 123, by operating the input unit 112, the user inputs a URL of a web page that the user desires to browse. In the search bar 124, by operating the input unit 112, the user inputs a word to be searched for by a predetermined search engine.

The display area 121 displays a plurality of bookmark display items 125 each corresponding to a corresponding one of bookmarked web pages. Each of the bookmark display items 125 is, for example, a thumbnail image generated by capturing a screen of a corresponding web page. This thumbnail image is generated by capturing a screen of a corresponding web page when the user bookmarks the web page. The plurality of bookmark display items 125 are virtually arranged in a substantially cylindrical shape, and virtually and automatically rotated in a predetermined direction (direction indicated by an arrow in FIG. 4). In one rotation of the plurality of bookmark display items 125, all the bookmark display items 125 are sequentially displayed in a predetermined number on the display area 121. It should be noted that the user can operate the input unit 112 to stop the rotation of the bookmark display items 125.

It is also possible that the use operates the input unit 112 to sequentially focus-display the bookmark display items 125 displayed on the display area 121 one by one. The focus display displays, for example, a target bookmark display item 125 with a thick rectangular frame surrounding a periphery of a target bookmark display item 125.

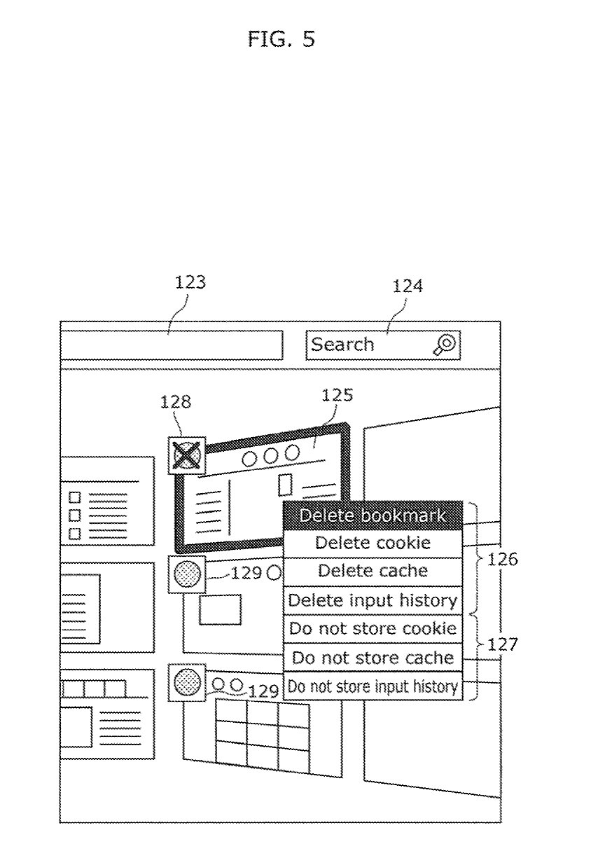

FIG. 5 is an enlarged diagram of a part of the bookmark list screen. As illustrated in FIG. 5, while a specific bookmark display item 125 is focus-displayed, the user operates the input unit 112 to display, on the display area 121, a deletion menu 126 and a setting menu 127 of the focus-displayed bookmark display item 125.

The deletion menu 126 includes four menus displaying “Delete bookmark”, “Delete cookie”, “Delete cache”, and “Delete input history”. If the menu “Delete bookmark” is selected and executed, bookmark information of a web page corresponding to the focus-displayed bookmark display item 125 is deleted from the nonvolatile storage area 102a. Here, when the bookmark information of the web page is to be deleted, the web browser control unit 101 may not delete pieces of history information (cookie, cache data, and input history data) of the web page from the nonvolatile storage area 102a, but delete the pieces of history information when the web browser is dosed or the web browser is opened next. If the menu “Delete cookie” is selected and executed, a cookie of the web page corresponding to the focus-displayed bookmark display item 125 is deleted from the nonvolatile storage area 102a. If the menu “Delete cache” is selected and executed, cache data of the web page corresponding to the focus-displayed bookmark display item 125 is deleted from the nonvolatile storage area 102a. If the menu “Delete input history” is selected and executed, input history data of the web page corresponding to the focus-displayed bookmark display item 125 is deleted from the nonvolatile storage area 102a. As described above, the use of the deletion menu 126 allows the user to independently delete pieces of history information of a bookmarked web page. It should be noted that FIG. 5 illustrates the situation where the menu “Delete bookmark” is selected.

The setting menu 127 includes three menus displaying “Do not store cookie”, “Do not store cache”, and “Do not store input history”. If the menu “Do not store cookie” is selected and executed, a cookie of a web page corresponding to the focus-displayed bookmark display item 125 is deleted from the nonvolatile storage area 102a every time the web browser is opened. If the menu “Do not store cache” is selected and executed, cache data of the web page corresponding to the focus-displayed bookmark display item 125 is deleted from the nonvolatile storage area 102a every time the web browser is opened. If the menu “Do not store input history” is selected and executed, input history data of the web page corresponding to the focus-displayed bookmark display item 125 is deleted from the nonvolatile storage area 102a every time the web browser is opened.

It should be noted that, if the menu “Do not store cookie” is selected and executed, this menu is changed to a menu “Store cookie”. If the menu “Store cookie” is selected and executed, the cookie of the web page corresponding to the focus-displayed bookmark display item 125 is not deleted afterwards from the nonvolatile storage area 102a even if the web browser is opened. The same goes for the menus “Do not store cache” and “Do not store input history”.

If the setting menu 127 performs setting to prohibit storing of a cookie into the nonvolatile storage area 102a, a mark 128 is displayed at the upper-left part of the focus-displayed bookmark display item 125 so as to indicate the prohibition. The mark 128 is, for example, a mark having a symbol X on a cooked cookie image. On the other hand, if the setting menu 127 performs setting to permit storing of a cookie into the nonvolatile storage area 102a, a mark 129 is displayed at the upper-left part of the focus-displayed bookmark display item 125 so as to indicate the permission. The mark 129 is, for example, a mark with a cooked cookie image. The mark display for cookie storing may be performed also for cache data and input history data.

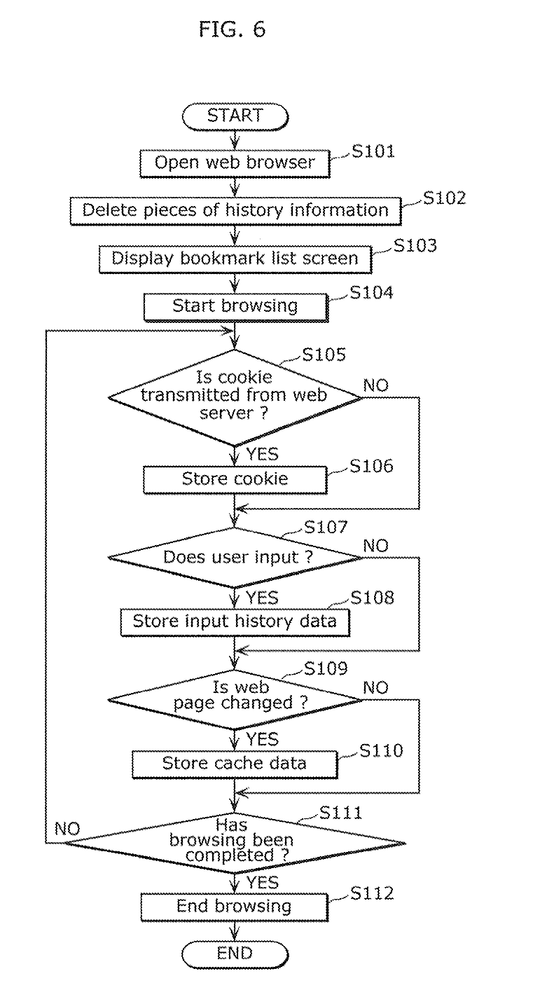

Next, a web browser control method performed by the web browser control device 10 according to the present embodiment is described. FIG. 6 is a flowchart of the web browser control method performed by the web browser control device according to Embodiment 1.

First, the user operates the input unit 112 to cause the web browser control unit 101 to open a web browser (S101). When the web browser is opened, the web browser control unit 101 deletes, from the nonvolatile storage area 102a, pieces of history information (cookie, cache data, and input history data) of each web page that has not been bookmarked (S102).

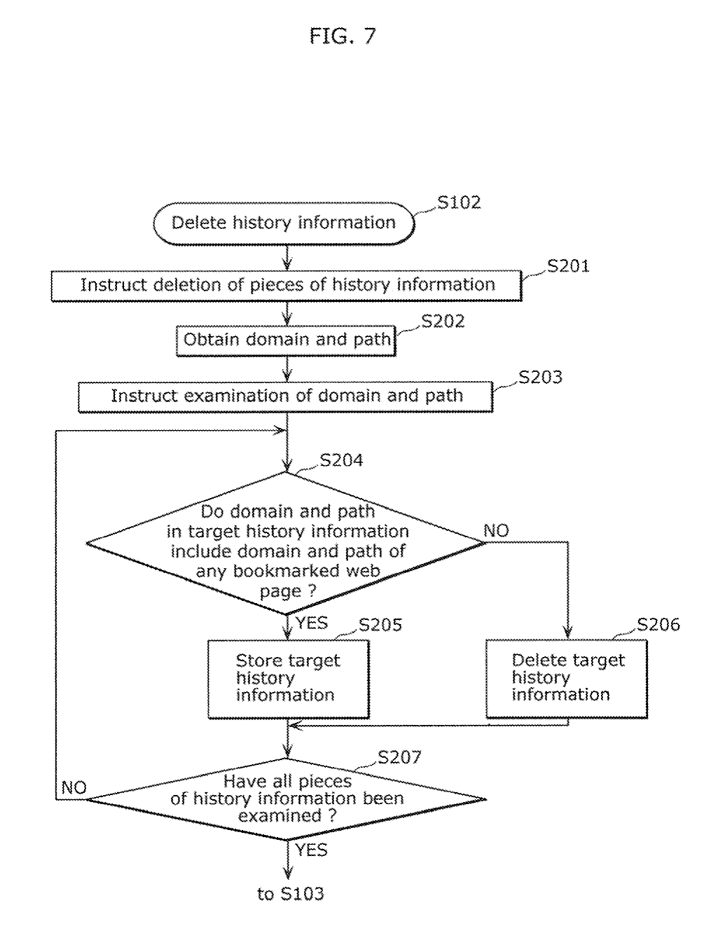

FIG. 7 is a flowchart of detailed flow of the history information deletion step in FIG. 6. As illustrated in FIG. 7, when the web browser is opened, the browser core unit 106 instructs the processing unit 107 to delete pieces of history information of web pages not bookmarked (S201). According to the instructions from the browser core unit 106, the processing unit 107 obtains, from the nonvolatile storage area 102a, (a) domains and paths of ail of bookmarked web pages and (b) domains and paths in pieces of history information of all of browsed web pages (S202). After that, the processing unit 107 instructs the domain examination unit 108 to perform the domain/path examination (S203).

According to the instructions from the processing unit 107, the domain examination unit 108 performs the domain/path examination on each of cookies, pieces of cache data, and pieces of input history data. First, the domain examination unit 108 determines whether or not a domain and a path in a target cookie include a domain and a path of any one of the bookmarked web pages. This determination (examination) of the domain examination unit 108 is performed in the following manner. If the domain examination unit 108 determines the domain and the path in the cookie include a domain and a path of a bookmarked web page (YES at S204), then the processing unit 107 causes the nonvolatile storage area 102a to keep holding the cookie (S205). On the other hand, if the domain examination unit 108 determines the domain and the path in the cookie do not include a domain and a path of any bookmarked web page (NO at S204), then the processing unit 107 delete the cookie from the nonvolatile storage area 102a (S206). The above processing is performed for each of cookies stored in the nonvolatile storage area 102a.

It should be noted that the same processing of Steps S204 to S206 is performed on each piece of cache data and each piece of input history data stored in the nonvolatile storage area 102a.

By performing the domain/path examination on all the pieces of history information obtained from the processing unit 107, pieces of history information of web pages not bookmarked are deleted from the nonvolatile storage area 102a. As a result, the nonvolatile storage area 102a holds only pieces of history information of web pages that have been bookmarked.

After performing the domain/path examination on all the pieces of history information obtained from the processing unit 107 (YES at 5207), the browser core unit 106 instructs the display control unit 103 to display a bookmark list screen. According to the instructions from the browser core unit 106, the display control unit 103 obtains pieces of bookmark information of web pages from the nonvolatile storage area 102a. Then, according to the obtained pieces of bookmark information, the display control unit 103 causes the display unit 111 to display a bookmark list screen (S103).

According to user's operation using the input unit 112, a bookmark display item 125 focus-displays, on the bookmark list screen, a web page that the user desires to browse. In this state, the user further operates the input unit 112 to display, on the display unit 111, the web page corresponding to the focus-displayed bookmark display item 125, and open browsing (S104).

During the browsing, if a cookie is transmitted from the web server 12 to the web browser control unit 101 (YES at S105), then the processing unit 107 stores the cookie into the nonvolatile storage area 102a (S106).

If, during the browsing, the user operates the input unit 112 to input a character string in an input area of the web page (YES at 5107), then the processing unit 107 stores the input history data into the nonvolatile storage area 102a (S108). Here, the input history data is stored in association with a URL of the web page on which the user has inputted the character string.

Furthermore, during the browsing, if the user operates the input unit 112 to change the web page to a different web page (YES at 5109), then cache data of the new web page is stored in the nonvolatile storage area 102a (S110).

As described above, since a cookie and the like are stored into the nonvolatile storage area 102a during browsing, browsing using the cookie is possible even in browsing of a web page using a cookie in session management.

If a web page not bookmarked is to be browsed, a URL of the desired web page is inputted in the location bar 123. In this case, the above processing of Steps S105 to S110 is also performed.

If the user wishes to end the browsing (YES at S111), then the user operates the input unit 112 to cause the web browser control unit 101 to close the web browser (S112). It should be noted that, when the web browser is opened again after the closing, the processing for deleting pieces of history information related to web pages not bookmarked is performed in the above-described manner.

The web browser control device 10 according to the present embodiment can produce the following effects. A bookmarked web page has a possibility of being watched by a plurality of users using the television receiver 11. Therefore, the user is generally unlikely to bookmark web pages which the user does not want the other users to know as web pages browsed by the user. Therefore, if pieces of history information of such web page not bookmarked are deleted from the nonvolatile storage area 102a when the web browser is opened, privacy of the user is sufficiently protected. On the other hand, pieces of history information of web pages that have been bookmarked are held in the nonvolatile storage area 102a. It is therefore possible, for example, to keep customizing information and the like of the web page even if the user is switched to another. As a result, a usability in browsing by a web browser can be enhanced.

Furthermore, since a bookmark list screen is displayed on the display unit 111 when the web browser is opened, the user can easily recognize that the other users using the television receiver 11 also watch the same bookmark list screen. Moreover, the user is likely to bookmark web pages that the user frequently browses. Therefore, the bookmark list screen is displayed on the display unit 111 when the web browser is opened, so that the user can easily browse the bookmarked web pages.

It should be noted that it has been described in the present embodiment that pieces of history information of web pages not bookmarked are deleted from the nonvolatile storage area 102a when the web browser is opened, but it may be when the web browser is closed that pieces of history information of web pages not bookmarked are deleted from the nonvolatile storage area 102a. The above aspect can also produce the same effects as described above.

It should also be noted that it has been described in the present embodiment that pieces of history information of a web page include a cookie, cache data, and input history data, but the pieces of history information may further include web page browsing history data and web page relevance data. The web page browsing history data is data regarding a URL of a browsed web page and date/month/year of the browsing. The web page relevance data is data regarding a screen image or a referrer of the browsed web page. The web page relevance data is stored in the nonvolatile storage area 102a in association with a URL of a web page for which the web page relevance data is obtained. It should also be noted that pieces of history information of a web page may include at least one of a cookie, cache data, input history data, web page browsing history data, and web page relevance data.

It should also be noted that it has been described in the present embodiment that the storage unit 102 includes the nonvolatile storage area 102a, but if the web browser control device 10 is a device that is kept being powered ON for a long time, the storage unit 102 may include a volatile storage area instead of the nonvolatile storage area 102a.

### Embodiment 2

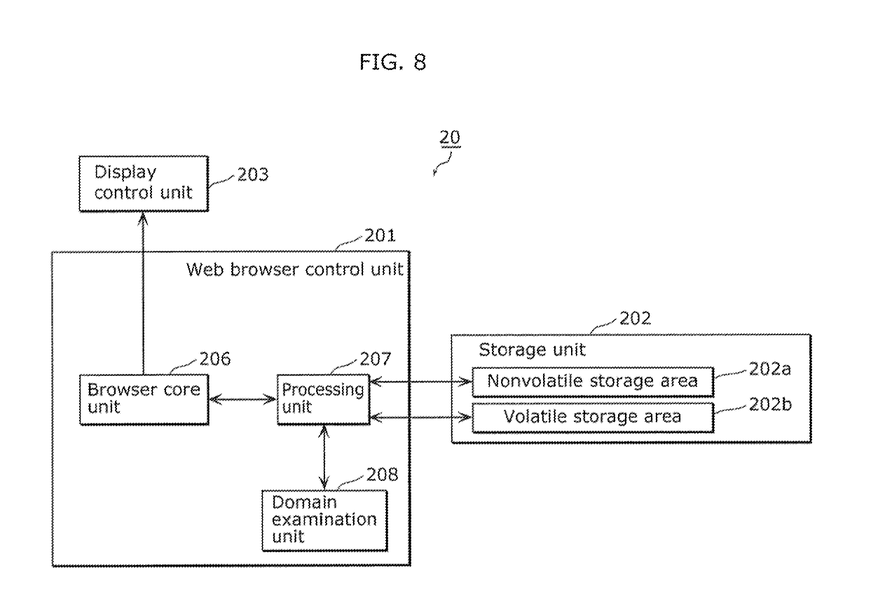

FIG. 8 is a block diagram illustrating a structure of a web browser control unit in a web browser control device according to Embodiment 2 of the present invention. As illustrated in FIG. 8, a storage unit 202 in a web browser control device 20 includes a nonvolatile storage area as a first storage area and a volatile storage area 202b as a second storage area. The nonvolatile storage area 202a is, for example, a nonvolatile memory or the like. The volatile storage area 202b is, for example, a volatile memory or the like.

According to the instructions from a browser core unit 206, a processing unit 207 in a web browser control unit 201 obtains, from the nonvolatile storage area 202a, (a) domains and paths of browsed and bookmarked web pages and (b) domains and paths in pieces of history information of all browsed web pages, and therefore instructs a domain examination unit 208 to examine the domains and paths. In addition, based on the examination results of the domain examination unit 208, the processing unit 207 stores pieces of history information of the bookmarked web pages into the nonvolatile storage area 202a, and stores pieces of history information of web pages not bookmarked into the volatile storage area 202b.

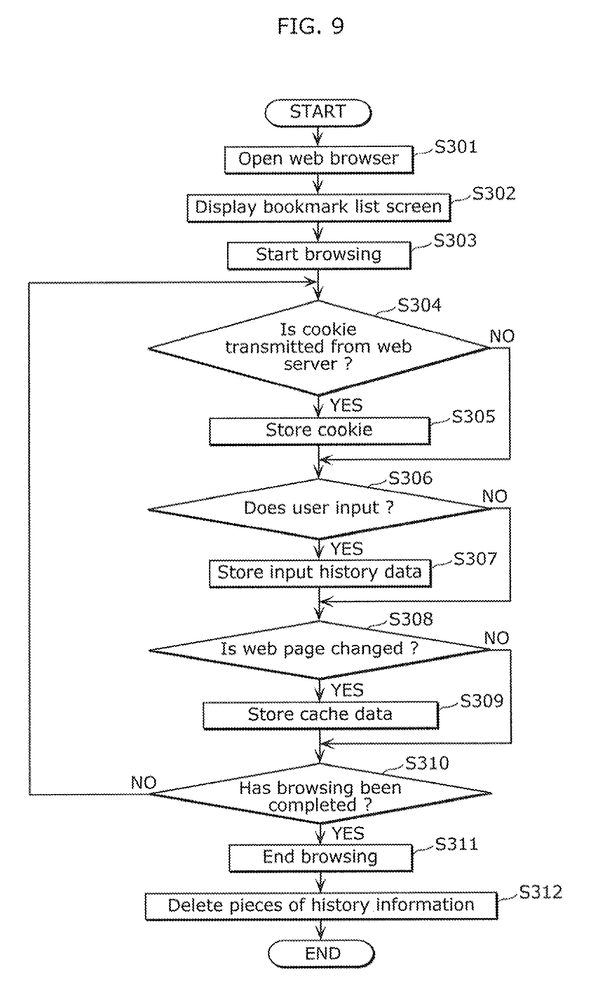

Next, a web browser control method performed by the web browser control device 20 according to the present embodiment is described. FIG. 9 is a flowchart for explaining a flow of the web browser control method performed by the web browser control device according to Embodiment 2.

First, a user operates an input unit (not illustrated) to cause the web browser control unit 201 to open a web browser (S301). When the web browser is opened, a browser core unit 206 instructs a display control unit 203 to display a bookmark list screen. According to the instructions from the browser core unit 206, the display control unit 203 obtains pieces of bookmark information of web pages from the nonvolatile storage area 202a and thereby causes a display unit (not illustrated) to display the bookmark list screen (S302). By user's operation on the bookmark list screen, a web page is displayed on the display unit and browsing starts (S303).

During the browsing, when a cookie of the displaying web page is transmitted from a web server (not illustrated) to the web browser control unit 201 (YES at S304), then the processing unit 207 stores the cookie into the nonvolatile storage area 202a if the web page is bookmarked, or into the volatile storage area 202b if the web page is not bookmarked (S305).

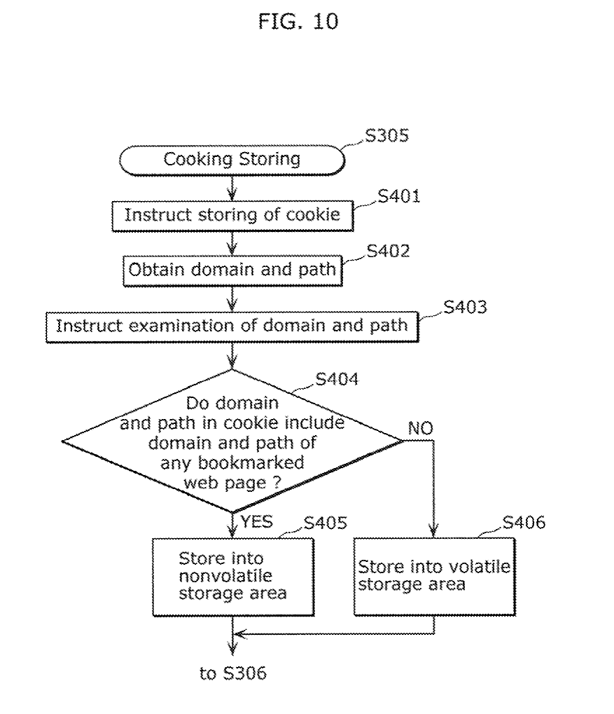

FIG. 10 is a flowchart of a detailed flow of the history information storing step in FIG. 9. As seen in FIG. 10, the browser core unit 206 instructs the processing unit 207 to store the cookie transmitted from the web server (S401). According to the instructions from the browser core unit 206, the processing unit 207 obtains, from the nonvolatile storage area 202a, domains and paths of all of bookmarked web pages (S402). After that, the processing unit 207 instructs the domain examination unit 208 to perform the domain/path examination (S403).

According to the instructions from the processing unit 207, the domain examination unit 208 determines whether or not a domain and a path in the cookie transmitted from the web server include a domain and a path of any one of the bookmarked web pages. This determination (examination) of the domain examination unit 208 is performed in the same manner as described in Embodiment 1. If the domain examination unit 208 determines that the domain and the path in the cookie include a domain and a path of a bookmarked web page (YES at S404), then the processing unit 207 stores the cookie into the nonvolatile storage area 202a (S405). On the other hand, if the domain examination unit 208 determines that the domain and the path in the cookie do not include a domain and a path of any bookmarked web page (NO at S404), then the processing unit 207 stores the cookie into the volatile storage area 202b (S406). Then, the cookie storing processing is completed.

After that, in the case where, during browsing, the user operates the input unit to input a character string in an input area of the browsing web page (YES at S306), then the processing unit 207 stores input history data of the input into the nonvolatile storage area 202a if the web page is bookmarked, and stores the input history data into the volatile storage area 202b if the web page is not bookmarked (S307). The input history data storing processing is performed in the same manner as described in the cookie storing processing, so that it is not described.

After that, during the browsing, if the user operates the input unit to change the currently-browsing web page to a different web page (YES at S308), then the processing unit 207 stores cache data of the newly-browsing web page into the nonvolatile storage area 202a if the web page is bookmarked, and stores the cache data into the volatile storage area 202b if the web page is not bookmarked (S309). The cache data storing processing is performed in the same manner as described in the cookie storing processing, so that it is not described.

As described above, pieces of history information of bookmarked web pages are stored in the nonvolatile storage area 202a, while pieces of history information of web pages not bookmarked are stored in the volatile storage area 202b.

If the user wishes to end the browsing (YES at 5310), then the user operates the input unit to cause the web browser control unit 201 to close the web browser (S311). When the web browser is closed, the processing unit 207 deletes all the pieces of history information of web pages from the volatile storage area 202b (S312).

It should be noted that it has been described in the present embodiment that pieces of history information of web pages not bookmarked are deleted from the volatile storage area 202b when the web browser is closed, but it may be when the web browser is opened that the pieces of history information of web pages not bookmarked are deleted from the volatile storage area 202b. In this case, if the web browser control device 20 is powered OFF after closing the web browser, the pieces of history information of web pages as stored in the volatile storage area 202b are erased.

It should also be noted that it has been described in the present embodiment that pieces of history information of bookmarked web pages are stored in the nonvolatile storage area 202a, but the pieces of history information of bookmarked web pages may be stored both in the nonvolatile storage area 202a and the volatile storage area 202b. It is thereby possible to increase a speed of displaying the bookmarked web pages.

It should also be noted that it has been described in the present embodiment that the storage unit 202 includes the nonvolatile storage area 202a, but if the web browser control device 20 is a device that is kept being powered ON for a long time, the storage unit 202 may include a volatile storage area instead of the nonvolatile storage area 202a.

### Embodiment 3

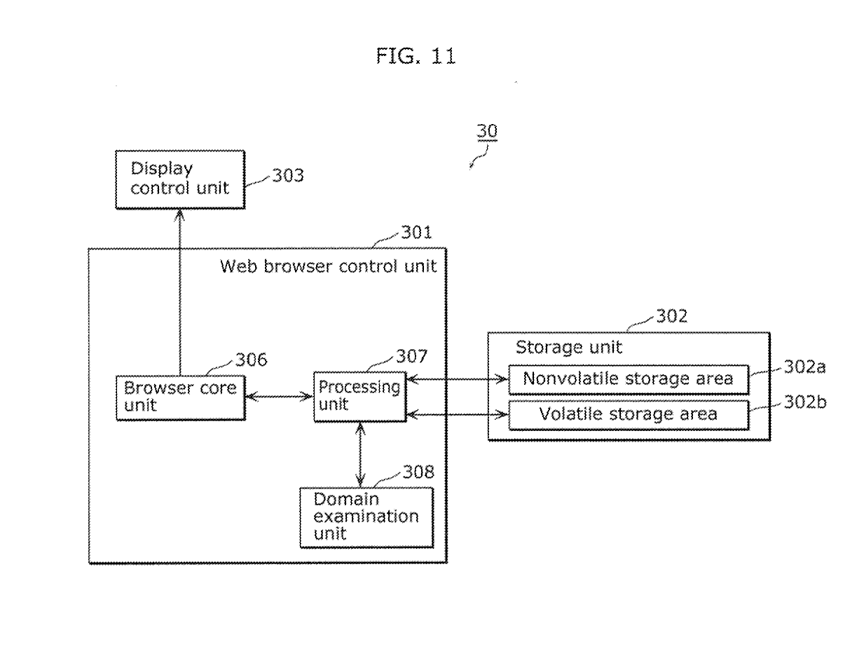

FIG. 11 is a block diagram illustrating a structure of a web browser control unit in a web browser control device according to Embodiment 3 of the present invention. As illustrated in FIG. 11, a storage unit 302 in a web browser control device 30 includes a nonvolatile storage area 302a as a first storage area and a volatile storage area 302b as a second storage area.

According to the instructions from a browser core unit 306, a processing unit 307 in a web browser control unit 301 obtains, from the nonvolatile storage area 302a, domains and paths of bookmarked web pages, and therefore instructs a domain examination unit 308 to examine the domains and paths. Furthermore, according to the examination results of the domain examination unit 308, among the pieces of history information of web pages which are stored in the nonvolatile storage area 302a, the processing unit 307 permits use (including transmission) of pieces of history information of web pages that have been bookmarked, and prohibits use (including transmission) of pieces of history information of web pages that are not bookmarked.

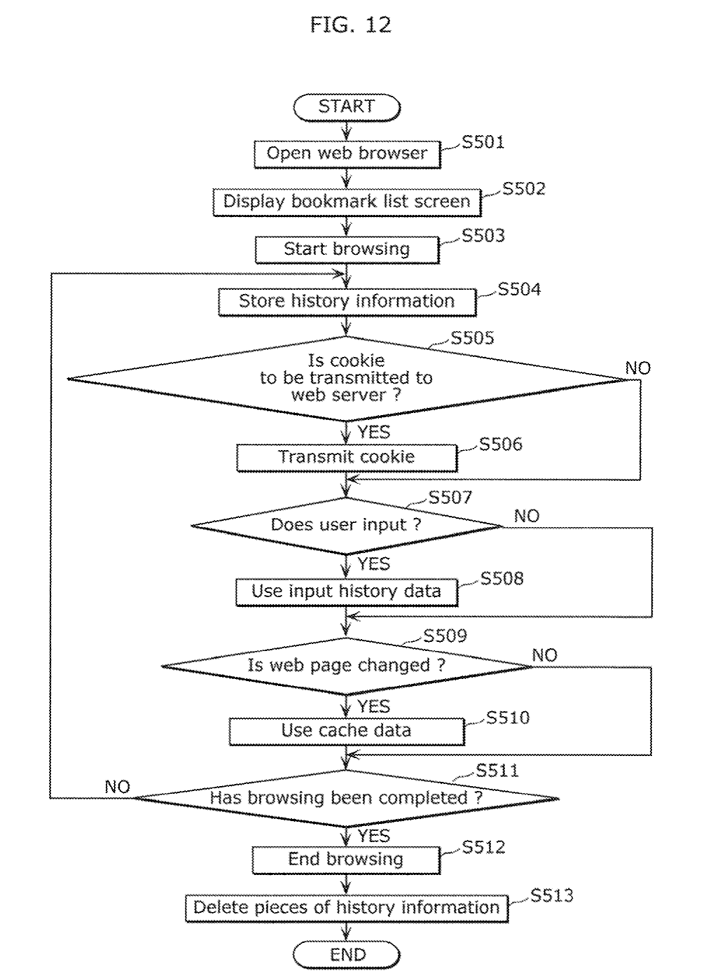

Next, the description is given for a flow of the web browser control method performed by the web browser control device 30 according to the present embodiment. FIG. 12 is a flowchart for explaining a flow of the web browser control method performed by the web browser control device according to Embodiment 3.

First, a user operates an input unit (not illustrated) to cause the web browser control unit 301 to open a web browser (S501). When the web browser is opened, the browser core unit 306 instructs a display control unit 303 to display a bookmark list screen. According to the instructions from the browser core unit 306, the display control unit 303 obtains pieces of bookmark information of web pages from the nonvolatile storage area 302a and thereby causes a display unit (not illustrated) to display the bookmark list screen (S502). By user's operation on the bookmark list screen, a web page is displayed on the display unit and browsing starts (S503).

During the browsing, the processing unit 307 stores a cookie, cache data, and input history data of the browsing web page into both the nonvolatile storage area 302a and the volatile storage area 302b (S504).

When the web browser control unit 301 is to transmit a cookie of the browsing web page to a web server (not illustrated) (YES at 5505), then the processing unit 307 permits transmission of the cookie if the web page has been bookmarked, and prohibits the transmission of the cookie if the web page is not bookmarked (in other words, among pieces of history information of web pages as stored in the nonvolatile storage area 302a, the processing unit 307 permits transmission of cookies of bookmarked web pages and prohibits transmission of cookies of web pages not bookmarked) (S506).

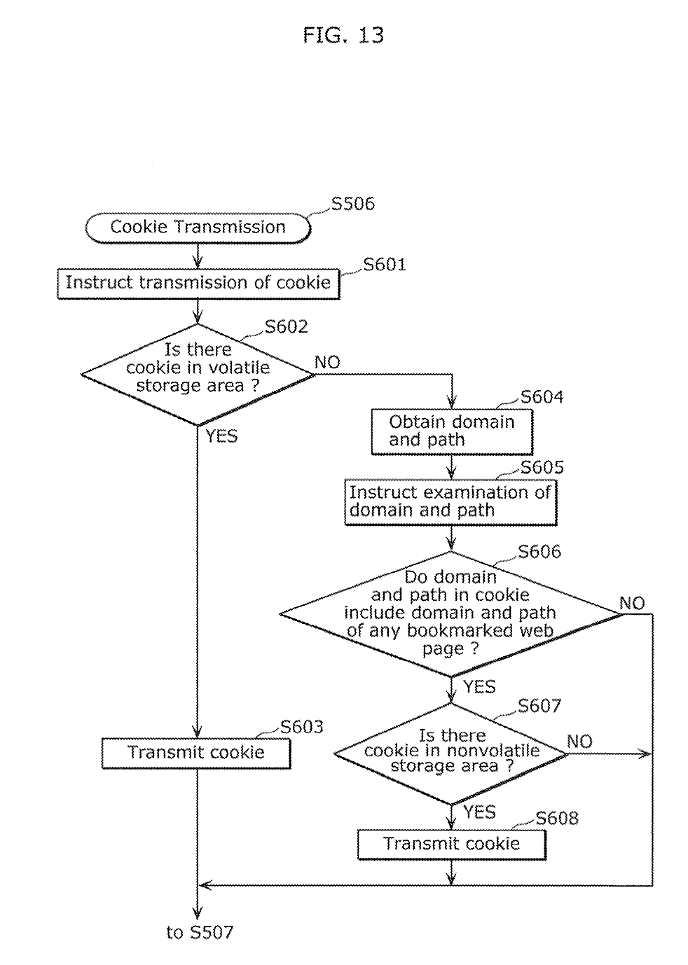

FIG. 13 is a flowchart of a detailed flow of the cookie transmission processing in FIG. 12. As seen in FIG. 13, the browser core unit 306 instructs the processing unit 307 to transmit the cookie to the web server (S601). According to the instructions from the browser core unit 306, the processing unit 307 examines whether or not the volatile storage area 302b holds the cookie having a corresponding domain and a corresponding path. If it is determined that the volatile storage area 302b holds the cookie having the corresponding domain and the corresponding path (YES at 5602), then the processing unit 307 obtains the cookie from the volatile storage area 302b and transmits the obtained cookie to the web server (S603).

On the other hand, if the volatile storage area 302b does not hold the cookie having the corresponding domain and the corresponding path (NO at 5602), then the processing unit 307 obtains, from the nonvolatile storage area 302a, domains and paths of all of the bookmarked web pages (S604). After that, the processing unit 307 instructs the domain examination unit 308 to perform the domain/path examination (S605).

According to the instructions from the processing unit 307, the domain examination unit 308 determines whether or not the domain and the path in the cookie that is instructed to be transmitted include a domain and a path of any of bookmarked web pages. This determination (examination) of the domain examination unit 308 is performed in the same manner as described in Embodiment 1. If the domain examination unit 308 determines that the domain and the path in the cookie include a domain and a path of a bookmarked web page (YES at 5606), then the processing unit 307 searches the nonvolatile storage area 302a for the cookie.

If the cookie is found in the nonvolatile storage area 302a (YES at 5607), then the processing unit 307 obtains the cookie from the nonvolatile storage area 302a and transmits the obtained cookie to the web server (S608). If the cookie is not found in the nonvolatile storage area 302a (NO at 5607), then the processing unit 307 terminates the processing without transmitting the cookie.

If the domain examination unit 308 determines that the domain and the path in the cookie that is instructed to be transmitted do not include a domain and a path of any of bookmarked web pages (NO at 5606), then the processing unit 307 terminates the processing without transmitting the cookie. As described above, the cookie transmission processing is completed.

After that, in the case where, during browsing, the user operates the input unit to input a character string in an input area of the web page (YES at 5507), then the processing unit 307 permits use of the input history data of the input if the web page is bookmarked, and prohibits use of the input history data if the web page is not bookmarked (in other words, among pieces of input history information of web pages as stored in the nonvolatile storage area 302a, the processing unit 307 permits use of input history data of bookmarked web pages and prohibits use of input history data of web pages not bookmarked) (S508). The input history data use processing is performed in the same manner as described in the cookie transmission processing, so that it is not described.

After that, during the browsing, if the user operates the input unit to change the currently-browsing web page to a different web page (YES at 5509), then the processing unit 307 permits use of cache data of the newly-browsing web page if the web page is bookmarked, and prohibits use of the cache data if the web page is not bookmarked (in other words, among pieces of history information of web pages as stored in the nonvolatile storage area 302a, the processing unit 307 permits use of cache data of bookmarked web pages and prohibits use of cache data of web pages not bookmarked) (S510) The cache data use processing is performed in the same manner as described in the cookie transmission processing, so that it is not described.

As described above, among pieces of history information stored in the nonvolatile storage area 302a, pieces of history information of bookmarked web pages are used, while pieces of history information of web pages not bookmarked are not used.

If the user wishes to end the browsing (YES at S511), then the user operates the input unit to cause the web browser control unit 301 to close the web browser (S512). When the web browser is closed, the processing unit 30 deletes all the pieces of history information of web pages from the volatile storage area 302b (S513).

It should be noted that it has been described in the present embodiment that pieces of history information of web pages not bookmarked are deleted from the volatile storage area 302b when the web browser is closed, but it may be when the web browser is opened that the pieces of history information of web pages not bookmarked are deleted from the volatile storage area 302b. In this case, if the web browser control device 30 is powered OFF after closing the web browser, the pieces of history information of web pages as stored in the volatile storage area 302b are automatically deleted.

It should also be noted that it has been described in the present embodiment that the storage unit 302 includes the nonvolatile storage area 302a, but if the web browser control device 30 is a device that is kept being powered ON for a long time, the storage unit 302 may include a volatile storage area instead of the nonvolatile storage area 302a.

### Embodiment 4

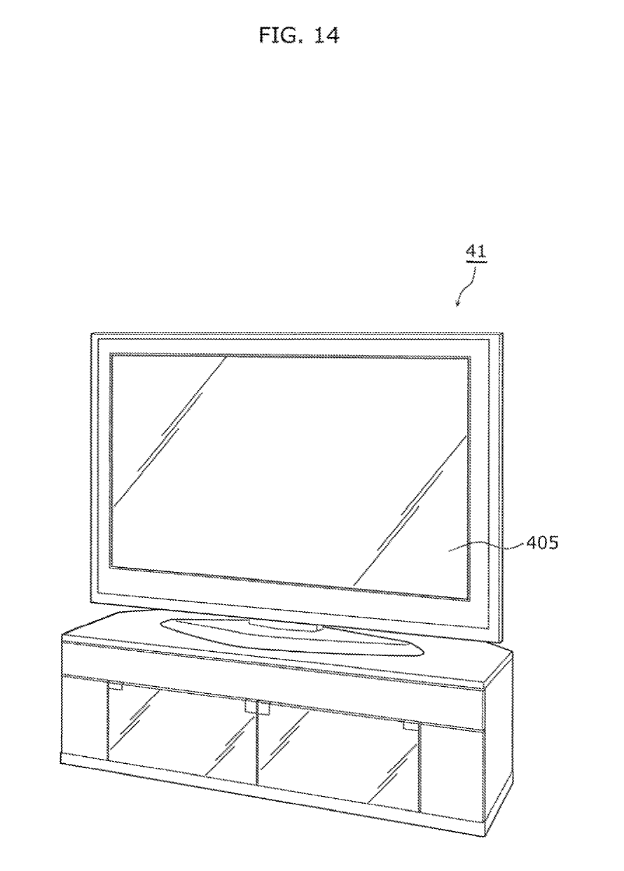

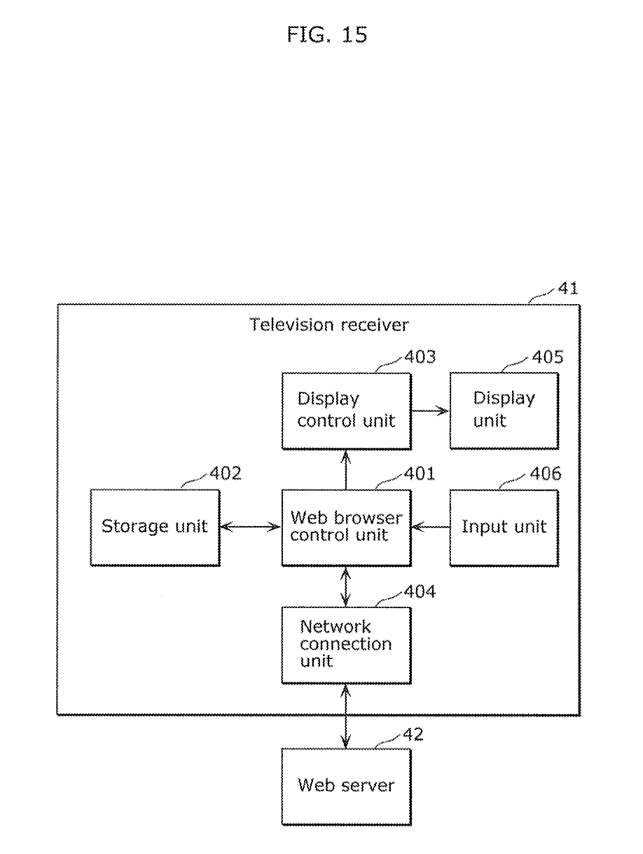

FIG. 14 is an external oblique perspective view of a television receiver according to Embodiment 4. FIG. 15 is a block diagram illustrating a functional structure of the television receiver of FIG. 14.

As illustrated in FIGS. 14 and 15, a television receiver 41 includes a web browser control unit 401, a storage unit 402, a display control unit 403, a network connection unit 404, a display unit 405, and an input unit 406.

The web browser control unit 401, the storage unit 402, the display control unit 403, and the network connection unit 404 are the same as the web browser control unit 101, the storage unit 102, the display control unit 103, and the network connection unit 104, respectively, in the web browser control device 10 according to Embodiment 1. The display unit 405 and the input unit 406 are the same as, for example, the display unit 111 and the input unit 112, respectively, in the television receiver 11 according to Embodiment 1.

The television receiver 41 further includes a tuner unit (not illustrated) that receives broadcast signals to obtain video signals. The display unit 405 displays the video signals obtained by the tuner unit.

Therefore, the television receiver 41 according to the present embodiment can produce the same effects as those in Embodiment 1. It should also be noted that each of the web browser control unit 401, the storage unit 402, the display control unit 430, and the network connection unit 404 may have the same structure as that of a corresponding structural element in the web browser control device 20 of Embodiment 2 or the same structure as that of a corresponding structural element in the web browser control device 30 of Embodiment 3.

It should also be noted that, in each of the above-described embodiments, each of the structural elements may be implemented to a dedicated hardware or executed by a suitable software program. Each of the structural elements may be implemented by reading a software program by a program execution unit, such as a Central Processing Unit (CPU) or a processor, from a recording medium such as a hard disk or a semiconductor memory, and executing the software program. An example of the software for implementing the web browser control device or the like in each of the above-described embodiments is a program as described below.

The program causes a computer to execute; causing a display unit to display a bookmark list screen showing a list of bookmarked web pages when a web browser is opened; storing, into a storage unit, pieces of history information of the web pages displayed on the display unit in a duration from when the web browser is opened to when the web browser is closed; and deleting pieces of history information of web pages not bookmarked from the storage unit when the web browser is closed or opened.

Although the web browser control devices, the web browser control methods, and the television receivers according to one or more aspects of the present invention have been described based on the above embodiments, the present invention is not limited to them. Those skilled in the art will be readily appreciate that various modifications and combinations of the structural elements in the embodiments are possible without materially departing from the novel teachings and advantages of the present invention. Accordingly, all such modifications and combinations are intended to be included within the scope of the present invention.

It should be noted that it has been described in the above embodiment that a bookmark list screen is displayed on the display unit when the web browser is opened. However, the bookmark list screen may be displayed on the display unit before the user starts browsing. For example, it is possible that advertisement or the like is displayed on the display unit after opening the web browser, then a bookmark list screen is displayed on the display unit, and finally browsing by the user starts. Therefore, the expression “when the browser is opened” may mean a period from when the web browser is opened to when the user starts browsing.

It should also be noted that it has been described in the above embodiments that the domain examination unit performs the examination for domains and paths, but the domain examination unit may perform the examination only for domains.

It should also be noted that it has been described in the above embodiments that pieces of history information of web pages are stored in a storage area in the web browser control device or the television receiver, but may be stored in an external storage area, such as a storage or a memory card accessible to a network, outside the web browser control device or the television receiver. Or, pieces of history information of web pages may be stored in a storage area in a web server on the Internet.

It should also be noted that it has been described in the above embodiments that the web browser control device is connected to the television receiver, but may be connected, for example, to a tablet information terminal, a table information terminal, or the like. Or, the web browser control device may be embedded in a tablet information terminal, a table information terminal, or the like.

It should also be noted that it has been described in the above embodiments that the bookmark list screen displays the deletion menu and the setting menu, but it is also possible that the setting menu is eliminated and the deletion menu includes only the menu “Delete bookmark”. Or, the deletion menu may include only menus “Delete bookmark”, “Delete cookie”, and “Delete cache”.

It should also be noted that it has been described in the above embodiments that the bookmark list screen displays the deletion menu and the setting menu, but it is also possible that the setting menu is eliminated and only the deletion menu is displayed.

It should also be noted that it has been described in the above embodiment that the input history data is data inputted by a remote controller serving as the input unit, but the input history data is not limited to such data and may be, for example, data inputted by a keyboard as the input unit or audio data inputted by a microphone as the input unit.

It should also be noted that it has been described in the above embodiment that the web browser control unit instructs deletion of pieces of history information except pieces of history information of domains and sub-domains of bookmarked web pages when the web browser is closed or opened. However, the following structure is also possible. The web browser control unit uses exact phrase search instead of backward match search in the character string comparison performed by the domain examination unit, so as to delete, from the storage unit, pieces of history information except pieces of history information of domains and sub-domains of bookmarked web pages. It is also possible that, when the domain examination unit examines directory, the web browser control unit uses exact phrase search instead of forward match search in the character string comparison performed by the domain examination unit,

### INDUSTRIAL APPLICABILITY

The present invention can be used as a web browser control device, a web browser control method, or a television receiver each of which is capable of protecting privacy while a usability in browsing web pages is enhanced.

### REFERENCE SIGNS LIST

10, 20, 30 web browser control device
11, 41 television receiver
12 web server
101, 201, 301, 401 web browser control unit
102, 202, 302, 402 storage unit
102a, 202a, 302a nonvolatile storage area
103, 203, 303, 403 display control unit
104, 404 network connection unit
106, 206, 306 browser core unit
107, 207, 307 processing unit
108, 208, 308 domain examination unit
111, 405 display unit
112, 406 input unit
121 display area
122 display bar
123 location bar
124 search bar
125 bookmark display item
126 deletion menu
127 setting menu
128, 129 mark
202b, 302b volatile storage area

1. A web browser control device comprising:
a display control unit configured to cause web pages and a bookmark list screen to be displayed, the bookmark list screen showing a list of at least one bookmarked web page among the web pages:
a storage unit configured to store (a) pieces of history information of the web pages displayed by the display control unit and (b) bookmark information of the at least one bookmarked web page; and
a web browser control unit configured to (i) instruct, when a web browser is opened, the display control unit to cause the bookmark list screen to be displayed according to the bookmark information stored in the storage unit, and (ii) delete, when the web browser is closed or opened, (c) history information of at least one web page not bookmarked among the web pages from the storage unit.

2. The web browser control device according to claim 1,
wherein the storage unit includes a storage area, the storage area including a nonvolatile storage area and a volatile storage area,
the storage area holds (a) the pieces of the history information of the web pages displayed by the display control unit and (b) the bookmark information of the at least one bookmarked web page, and
the web browser control unit is configured, when the web browser is closed or opened, to delete, from the storage area, (c) the history information of the at least one web page not bookmarked among (a) the pieces of the history information of the web pages stored in the storage area, according to (a) the pieces of the history information of the web pages and (b) the bookmark information which are stored in the storage area.

3. The web browser control device according to claim 2,
wherein the storage area holds (a1) domains of the pieces in the history information of the web pages displayed by the display control unit and ( )) a domain in a Uniform Resource Locator (URL) of the at least one bookmarked web page, and
the web browser control unit includes:
a domain examination unit configured, when the web browser is closed or opened, to determine, for each of (a1) the domains in the pieces of the history information of the web pages stored in the storage area, whether or not a target domain includes (b1) the domain in the URL of the at least one bookmarked web page; and
a processing unit configured, when the web browser is closed or opened, to (i) keep holding history information having the target domain in the storage area when the domain examination unit determines that the target domain includes the domain in the URL, and (ii) delete the history information having the target domain from the storage area when the domain examination unit determines that the target domain does not include the domain in the URL.

4. The web browser control device according to claim 1,
wherein the storage unit includes a first storage area and a second storage area,
the first storage area holds (b) the bookmark information of the at least one bookmarked web page, and
the web browser control unit is configured to:
during a period from when the web browser is opened to when the web browser is closed, according to (b) the bookmark information stored in the first storage area, (i) store, into the first storage area, (b2) history information of the at least one bookmarked web page among the web pages displayed by the display control unit, and (ii) store, into the second storage area, (c) the history information of the at least one web page not bookmarked among the web pages displayed by the display control unit; and
delete, from the second storage area, (c) the history information of the at least one web page not bookmarked, when the web browser is closed or opened.

5. The web browser control device according to claim 4,
wherein the first storage area holds (b1) a domain in a URL of the at least one bookmarked web page, and
the web browser control unit includes:
a domain examination unit configured, during a period from when the web browser is opened to when the web browser is closed, to determine, for each of (a1) domains in the pieces of the history information of the web pages displayed by the display control unit, whether or not a target domain includes (b1) the domain in the URL of the at least one bookmarked web page; and
a processing unit configured to (i−1) store history information having the target domain into the first storage area when the domain examination unit determines that the target domain includes the domain in the URL, and (i−2) store the history information having the target domain into the second storage area when the domain examination unit determines that the target domain does not include the domain in the URL, and (ii) delete the history information having the target domain from the second storage area when the web browser is closed or opened.

6. The web browser control device according to claim 4,
wherein the first storage area is a nonvolatile storage area, and the second storage area is a volatile storage area.

7. The web browser control device according to claim 1,
wherein the storage unit includes a first storage area and a second storage area,
the first storage area holds (b) the bookmark information of the at least one bookmarked web page, and
the web browser control unit is configured, during a period from when the web browser is opened to when the web browser is closed, to:
(i) store (a) the pieces of the history information of the web pages displayed by the display control unit into both the first storage area and the second storage area, (ii) use the pieces of history information of the web pages which are stored in the second storage area when (e) history information of a web page to be used is stored in the second storage area, and (iii) determine, according to (b) the bookmark information stored in the first storage area, whether or not to use each of the pieces of the history information of the web pages which are stored in the first storage area when (e) the history information of the web page to be used is not stored in the second storage area; and
delete the pieces of the history information stored in the second storage area when the web browser is closed or opened.

8. The web browser control device according to claim 7,
wherein the first storage area holds (b1) a domain in a URL of the at least one bookmarked web page, and
the web browser control unit includes:
a domain examination unit configured, during a period from when the web browser is opened to when the web browser is closed, when (e) the history information of the web page to be used is not stored in the second storage area, to determine whether or not (e1) a domain in the history information of the web page to be used includes (b1) the domain in the URL of the at least one bookmarked web page; and
a processing unit configured (i) to use the pieces of the history information stored in the first storage area when the domain examination unit determines that (e1) the domain in the history information of the web page to be used includes (b1) the domain in the URL, (ii) not to use the pieces of the history information stored in the first storage area when the domain examination unit determines that (e1) the domain in the history information of the web page to be used does not include (b1) the domain in the URL, and (iii) to delete the pieces of the history information of the web pages which are stored in the second storage area when the web browser is closed or opened.

9. The web browser control device according to claim 7,
wherein the first storage area is a nonvolatile storage area, and the second storage area is a volatile storage area.

10. The web browser control device according to claim 1,
wherein the web browser control unit is configured to delete, from the storage unit, (a) the pieces of the history information of the web pages except (b2′) history information having a domain and a sub-domain of the at least one bookmarked web page when the web browser is closed or opened.

11. The web browser control device according to claim 1,
wherein the web browser control unit is configured to delete, from the storage unit, (a) the pieces of the history information of the web pages except (b2″) history information having a domain and a sub-directory of the at least one bookmarked web page when the web browser is closed or opened.

12. The web browser control device according to claim 1,
wherein the web browser control unit is configured to delete history information of a certain web page from the storage unit when bookmark information of the certain web page is deleted from the storage unit.

13. The web browser control device according to claim 1,
wherein (a) the pieces of the history information stored in the storage unit include at least one of a cookie, cache data, input history data, web page browsing history data, and web page relevance data.

14. The web browser control device according to claim 13,
wherein the web page relevance data is one of a screen image and a referrer.

15. The web browser control device according to claim 14,
wherein the web page relevance data is stored in the storage unit in association with a domain of a web page for which the web page relevance data is obtained.

16. The web browser control device according to claim 13,
wherein the input history data is stored in the storage unit in association with a domain of a web page on which an input indicated by the input history data is performed.

17. The web browser control device according to claim 1,
wherein the display control unit is configured to (i) display, on the bookmark list screen, a plurality of bookmark display items each corresponding to a corresponding one of bookmarked web pages among the web pages, allowing the bookmark display items to be focus-displayed one by one, and (ii) display a deletion menu on the bookmark list screen when a certain bookmark display item among the bookmark display items is focus-displayed, the deletion menu being used to delete history information of a web page corresponding to the certain bookmark display item from the storage unit.

18. The web browser control device according to claim 1,
wherein the display control unit is configured to (i) display, on the bookmark list screen, a plurality of bookmark display items each corresponding to a corresponding one of bookmarked web pages, allowing the bookmark display items to be focus-displayed one by one, and (ii) display a setting menu on the bookmark list screen when a certain bookmark display item among the bookmark display items is focus-displayed, the setting menu being used to set whether or not to store history information of a web page corresponding to the certain bookmark display item into the storage unit.

19. The web browser control device according to claim 18,
wherein the display control unit is configured, when the setting menu is set to store the history information of the web page corresponding to the certain bookmark display item into the storage unit, to display, on the bookmark list screen, a display showing that the history information of the web page corresponding to the certain bookmark display item is set to be stored in the storage unit.

20. The web browser control device according to claim 18,
wherein the display control unit is configured, when the setting menu is set not to store the history information of the web page corresponding to the certain bookmark display item into the storage unit, to display, on the bookmark list screen, a display showing that the history information of the web page corresponding to the certain bookmark display item is set not to be stored in the storage unit.

21. The web browser control device according to claim 17,
wherein the display control unit is configured to virtually arrange the bookmark display items in a substantially cylindrical shape on the bookmark list screen, and virtually rotate the bookmark display items in a predetermined direction.

22. The web browser control device according to claim 17,
wherein each of the bookmark display items is an image generated by capturing a screen of a corresponding one of the bookmarked web pages.

23. A web browser control method comprising:
displaying, on a display unit, a bookmark list screen showing a list of at least one bookmarked web page when a web browser is opened;
storing, in a storage unit, pieces of history information of web pages displayed on the display unit, during a period from when the web browser is opened and to when the web browser is closed; and
deleting, from the storage unit, history information of at least one web page not bookmarked among the web pages, when the web browser is closed or opened.

24. A television receiver comprising:
a display unit;
a display control unit configured to cause the display unit to display web pages and a bookmark list screen, the bookmark list screen showing a list of at least one bookmarked web page among the web pages;
a storage unit configured to store (a) pieces of history information of the web pages displayed by the display control unit and (b) bookmark information of the at least one bookmarked web page; and
a web browser control unit configured to (i) instruct, when a web browser is opened, the display control unit to cause the bookmark list screen to be displayed according to the bookmark information stored in the storage unit, and (ii) delete, when the web browser is closed or opened, (c) history information of at least one web page not bookmarked among the web pages from the storage unit.
